(19) United States
(12) Patent Application Publication
(10) Pub. No.: US 2024/0093942 A1
(43) Pub. Date: Mar. 21, 2024

(54) AN ELECTRICALLY HEATED APPARATUS

(71) Applicant: SHELL OIL COMPANY, Houston, TX (US)

(72) Inventor: Govert Gerardus Pieter VAN DER PLOEG, Amsterdam (NL)

(21) Appl. No.: 18/260,961

(22) PCT Filed: Feb. 8, 2022
(86) PCT No.: PCT/EP2022/052971

§ 371 Date: Jul. 11, 2023

(30) Foreign Application Priority Data
Feb. 10, 2021 (EP) 21156342.4

(51) Int. Cl. F27D 99/00; B01J 8/06; F27D 11/02

(52) U.S. Cl. CPC F27D 99/0006; B01J 8/062; F27D 11/02

(57) ABSTRACT

The present invention provides an electrically heated apparatus (1) at least comprising: —an electrically heated furnace (2) having walls (2A, 2B) defining a space (3); —a first row (4) of tubes (10) running through the space (3), wherein the tubes (10) have an inlet (11) and outlet (12) outside of the space (3); —a second row (14) of tubes (10) running through the space (3), wherein the tubes (10) have an inlet (11) and outlet (12) outside of the space (3); —a first set (5) of electrical radiative heating elements (20) located in the space (3), wherein the first set (5) comprises electrical radiative heating elements (20) located between the first (4) and second rows (14) of tubes (10).

The present invention relates to an electrically heated apparatus, in particular for performing gas conversion reactions or heating fluids at high temperatures.

Various electrically heated reactors are known in the art.

As an example, WO2020/002326A1 discloses a reactor configuration comprising at least one electrically heated furnace which defines a space, with at least one reactor tube placed in the furnace space. The reactor tube is heated using at least one electrical radiative heating element.

A problem associated with the above or other known electrical reactors is that known electrical reactors use the furnace walls to support the electrical radiative heating elements.

Another problem is that local overheating of the at least one electrical radiative heating elements may occur.

A further problem is that in case of premature failure or aging of the electrical radiative heating elements, a shutdown of the furnace is required.

It is an object of the present invention to overcome or minimize one or more of the above or other problems.

It is a further object of the present invention to provide an alternative electrically heated apparatus, in particular for high temperature reactions (such as above 400° C.), heating fluids at high temperatures and for large scale applications (using a multitude of tubes).

One or more of the above or other objects can be achieved by providing an electrically heated apparatus at least comprising:
an electrically heated furnace having walls defining a space;
a first row of tubes running through the space, wherein the tubes have an inlet and outlet outside of the space;
a second row of tubes running through the space, wherein the tubes have an inlet and outlet outside of the space;
a first set of electrical radiative heating elements located in the space, wherein the first set comprises electrical radiative heating elements between the first and second rows of tubes.

It has surprisingly been found according to the present invention that the apparatus according to the present invention may provide for a precise temperature control of the tubes and the fluids flowing through the tubes in an apparatus intended for large scale application (where a multitude of tubes is used). As a result, less unwanted by-products (such as coke formation) occur and longer operation times of the apparatus can be achieved.

A further advantage of the present invention is that the apparatus has a surprisingly simple and compact design (for a given number of tubes), even when a multitude of tubes is present. In view of the compact design, fewer electrical radiative heating elements may be needed. Due to its compact design, less furnace space is exposed to the outside ambient conditions, resulting in less heat loss and hence a more economic operation.

Also, in case of premature failure or aging of the electrical radiative heating elements, they can be replaced in a relatively easy manner without a shutdown of the apparatus being required.

The person skilled in the art will readily understand that the electrically heated apparatus can vary widely and may comprise several additional elements. As the person skilled in the art is familiar with how to design an electrically heated apparatus, this is not discussed here in detail.

As mentioned above, the apparatus comprises an electrically heated furnace having walls defining a (furnace) space. The walls of this furnace typically comprise some refractory and insulation to avoid undue heat leakage to outside of the furnace. The electrically heated furnace may be provided with some non-electrical heating (other than provided as the result of an exothermic reaction), but preferably at least 50%, preferably at least 80%, most preferably all, of the heating is provided by electrical heating.

The first and second rows of tubes running through the space may be varied widely, provided that the tubes have an inlet and outlet outside of the space. As a mere example, the tubes do not have to be straight (although preferred), but may have e.g. a S- or U-shape. In the event that U-shaped tubes are used, both the inlet and the outlet of the tubes may be at one side (e.g. at the top). Preferably, the first and second rows of tubes run substantially parallel. In case the apparatus is in the form of a reactor (and hence not merely used for heating), the tubes can be referred to with ‘reactor tubes’.

The first set of electrical radiative heating elements (located in the furnace space) are not particularly limited. Typically, for the heating of the electrical radiative heating elements, electric resistance heating is used (which makes use of the ‘Joule effect’). Generally, the electrical radiative heating elements are suited to be heated to a temperature above 300° C. Preferably, the electrical radiative heating elements are suited to be heated to a temperature in the range of from 400 to 1600° C. Preferably, the electrical radiative heating elements comprise NiCr, SiC, MoSi₂ or FeCrAl based resistance heating elements. Preferably, the electrical radiative heating elements are made from SiC, as this material maintains its strength under hot conditions (and thus does not require the presence of a support wall in the furnace space).

The person skilled in the art will readily understand that the electrical radiative heating elements can take many different shapes such as rods, plates, sheets, grids, (e.g. ceramic) rods with heating wire wrapped around the rods, etc.

According to the present invention, the first set of electrical radiative heating elements comprises at least electrical radiative heating elements between the first and second rows of tubes. These heating elements of the first set between the first and second rows of tubes may—dependent on the set-up of the apparatus—be placed above or next to each other, but preferably above each other. In addition to heating elements between the first and second rows of tubes, the first set may comprise further electrical radiative heating elements.

According to a preferred embodiment of the apparatus according to the present invention, the first set of electrical radiative heating elements comprises electrical radiative heating elements between a side wall of the space and the first row of tubes. In case several rows of tubes are present, then preferably heating elements are present between a side wall of the space and the row of tubes that is closest to the side wall. The presence of heating elements between a side wall of the space and the row of tubes that is closest to the side wall allows to minimize non-uniformity of heat flux (on the surface of the tubes) caused by a cold surface on the outside.

Furthermore, it is preferred that the apparatus comprises third and further rows of tubes, with electrical radiative heating elements positioned between the rows. Hence, in the latter case, the first set of electrical radiative heating elements comprises electrical radiative heating elements between each of the rows of tubes. Again, the first set of heating elements may comprise several heating elements between each row of tubes; preferably such heating elements are placed above each other between each row of tubes.

According to a preferred embodiment, each row of tubes comprises at least ten tubes. Preferably, the tubes in a specific row run substantially parallel.

Furthermore, it is preferred that the tubes extend in a substantially vertical manner. In such a vertical set-up of the tubes, it is preferred that the fluids flowing through the tubes flow downwards. Thus, in that case the inlet of the tubes is at the top and the outlet at the bottom.

According to an especially preferred embodiment of the apparatus according to the present invention, the apparatus further comprises a second set of electrical radiative heating elements located in the space, wherein the heating elements of the second set run substantially perpendicular to the heating elements of the first set. In this way, the heating elements of the first and second sets (and further sets) form a ‘grid-like’ pattern thereby increasing the uniformity of heat transfer from the heating elements to (the circumference of) the tubes. The electrical radiative heating elements of the second set may be the same as or similar to the heating elements of the first set.

Further it is preferred that the electrical radiative heating elements extend in a substantially horizontal manner.

To avoid undue overheating of the tubes it is preferred that the electrical radiative heating elements are not in direct contact with the tubes. In other words, the heating elements and the tubes do not touch each other, at least not in the furnace space.

Although the heating elements can have many forms, it is especially preferred that the electrical radiative heating elements are tubular heating elements, i.e. in the form of rods. Examples of suitable tubular heating elements are silicium carbide (SiC) rods, which are commercially available.

Such tubular SiC heating elements allow a compact design of the furnace space to be achieved, also as the tubular heating elements are self-supporting. As a result, no support walls are required for the heating elements in the furnace space. Preferably, the furnace space is indeed free of walls for supporting the tubular heating elements.

In a further aspect, the present invention provides a method for performing a fluid conversion reaction or heating using the electrically heated apparatus according to the present invention, wherein the method comprises at least the steps of:
a) feeding a feed stream via the inlets of the tubes;
b) subjecting the feed stream flowing through the tubes to a fluid conversion reaction or heating in the space of the apparatus using heating as generated by the electrical radiative heating elements, thereby obtaining one or more reaction products or a heated feed stream;
c) removing the one or more reaction products or the heated feed stream from the apparatus via the outlets of the tubes.

Hereinafter the present invention will be further illustrated by the following non-limiting drawings. Herein shows:

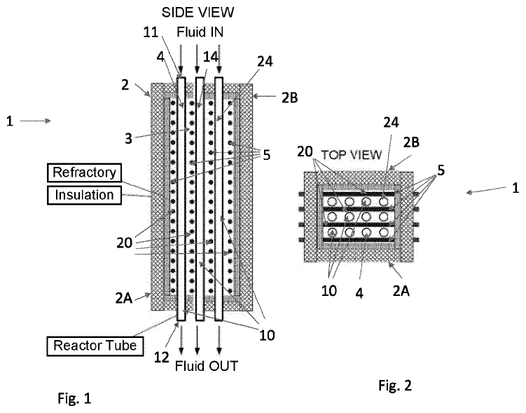

FIG. 1 schematically a side view of a first embodiment of the apparatus according to the present invention;

FIG. 2 schematically a top view of the apparatus of FIG. 1;

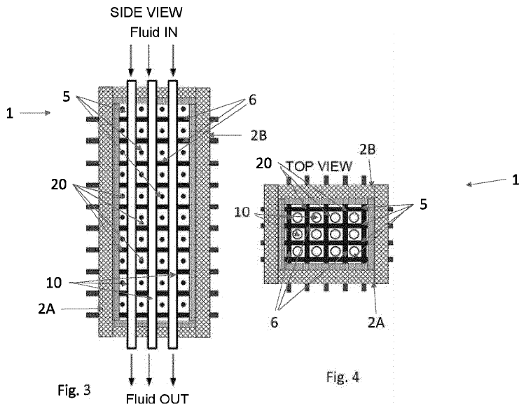

FIG. 3 schematically a side view of a second embodiment of the apparatus according to the present invention; and

FIG. 4 schematically a top view of the apparatus of FIG. 3.

For the purpose of this description, same reference numbers refer to same or similar components.

In the embodiment of FIG. 1 (and FIG. 3), the electrically heated apparatus of FIG. 1, generally referred to with reference number 1, is shown as a reactor. However, the person skilled in the art will readily understand that the apparatus can also be used for heating fluids, i.e. without a reaction taking place.

Reactor 1 of FIG. 1 comprises: an electrically heated furnace 2 having walls defining a furnace space 3 therein; a first row 4, a second row 14 and a third row 24 of reactor tubes 10; a first set 5 of electrical radiative heating elements 20. In FIG. 1 only side walls 2A and 2B have been indicated; however, the person skilled in the art will understand that in case of a rectangular reactor, four side walls, a top and a bottom are present.

The first set 5 of electrical radiative heating elements 20 is located in the space 3. The first set 5 comprises several electrical radiative heating elements 20 placed above each other between the first row 4 and second row 14 of reactor tubes 10. Furthermore, the first set 5 comprises further electrical radiative heating elements 20 between the side wall 2A of the space 3 and the first row 4 of reactor tubes 10, as well as between the side wall 2B and the third row 24 of reactor tubes 10.

As can be seen in FIG. 1, the reactor tubes 10 run through the space 3 and have an inlet 11 and outlet 12 outside of the space 3. Further, the reactor tubes 10 extend in a substantially vertical manner.

As can be further seen in FIG. 1, the electrical radiative heating elements 20 are tubular and extend in a substantially horizontal manner. Furthermore, the electrical radiative heating elements 20 are not in direct contact with the reactor tubes 10.

The walls 2A,2B of the furnace 2 are typically made from a heat-resistant and structural material and may be insulated to avoid undue leakage of heat from the inside of the furnace 2 to the outside thereof.

During use of the reactor of FIGS. 1 and 2, a fluid stream (typically a gas) is fed via the inlets 11 of the reactor tubes 10. The feed stream flowing through the reactor tubes 10 is then subjected to a fluid conversion reaction in (the reactor tubes 10 and in) the space 3 of the reactor 1 using heating as generated by the electrical radiative heating elements 20, thereby obtaining one or more reaction products.

Subsequently, the one or more reaction products are removed from the reactor 1 via the outlets 12 of the reactor tubes 10.

FIGS. 3 and 4 show side and top views of a second embodiment of the apparatus according to the present invention (again in the form of a reactor), wherein the reactor 1 further comprises a second set 6 of electrical radiative heating elements 20 located in the space 3. The heating elements 20 of the second set 6 run substantially perpendicular to the heating elements 20 of the first set 5, thereby obtaining a grid-like pattern of heating elements (when seen from above).

The person skilled in the art will readily understand that many modifications may be made without departing from the scope of the invention.

1. An electrically heated apparatus (1) at least comprising:
an electrically heated furnace (2) having walls (2A, 2B) defining a space (3);
a first row (4) of tubes (10) running through the space (3), wherein the tubes (10) have an inlet (11) and outlet (12) outside of the space (3);
a second row (14) of tubes (10) running through the space (3), wherein the tubes (10) have an inlet (11) and outlet (12) outside of the space (3);
a first set (5) of electrical radiative heating elements (20) located in the space (3), wherein the first set (5) comprises electrical radiative heating elements (20) located between the first (4) and second rows (14) of tubes (10).

2. The apparatus (1) according to claim 1, wherein the first set (5) of electrical radiative heating elements (20) comprises electrical radiative heating elements (20) between a side wall (2A) of the space (3) and the first row (4) of tubes (10).

3. The apparatus (1) according to claim 1, wherein the apparatus (1) comprises third (24) and further rows of tubes (10), with electrical radiative heating elements (20) positioned between the rows (4,14,24).

4. The apparatus (1) according to claim 1, wherein each row (4,14,24) of tubes (10) comprises at least ten tubes (10).

5. The apparatus (1) according to claim 1, wherein the tubes (10) extend in a substantially vertical manner.

6. The apparatus (1) according to claim 1, wherein the apparatus (1) further comprises a second set (6) of electrical radiative heating elements (20) located in the space (3), wherein the heating elements (20) of the second set (6) run substantially perpendicular to the heating elements (20) of the first set (5).

7. The apparatus (1) according to claim 1, wherein the electrical radiative heating elements (20) extend in a substantially horizontal manner.

8. The apparatus (1) according to claim 1, wherein the electrical radiative heating elements (20) are not in direct contact with the tubes (10).

9. The apparatus (1) according to claim 1, wherein the electrical radiative heating elements (20) are tubular heating elements.

10. A method for performing a fluid conversion reaction or heating using the electrically heated apparatus according to claim 1, wherein the method comprises at least the steps of:
a) feeding a feed stream via the inlets of the tubes;
b) subjecting the feed stream flowing through the tubes to a fluid conversion reaction or heating in the space of the apparatus using heating as generated by the electrical radiative heating elements, thereby obtaining one or more reaction products or a heated feed stream;
c) removing the one or more reaction products or a heated feed stream from the apparatus via the outlets of the tubes.
